(19) United States
(12) Patent Application Publication
(10) Pub. No.: US 2011/0262089 A1
(43) Pub. Date: Oct. 27, 2011

(54) SMALL-DIAMETER HIGH BENDING-RESISTANCE FIBER OPTIC CABLE

(76) Inventor: KUANG-BANG HSU, Taoyuan (TW)

(21) Appl. No.: 12/765,874

(22) Filed: Apr. 23, 2010

(51) Int. Cl. G02B 6/44

(52) U.S. Cl. 385/113

(57) ABSTRACT

A small-diameter high bending-resistance fiber optic cable adapted for obtaining a high tensile-resistance and a high bending-resistance is provided. The small-diameter high bending-resistance fiber optic cable is particularly adapted for being deployed in indoor pipelines. The small-diameter high bending-resistance fiber optic cable includes at least one optical fiber core, an outer protection sheath, and a plurality of tensile-resistance members. The optical fiber core is positioned in a center of the outer protection sheath. The tensile-resistance members are uniformly distributed in the outer protection sheath. The tensile-resistance members are made of aramid yarn material.

### BACKGROUND OF THE INVENTION

1. Field of the Invention

The present invention relates generally to a small-diameter high bending-resistance fiber optic cable. The fiber optic cable includes an outer protection sheath including a tensile-resistance member adapted for improving tensile strength and bending resistance of the fiber optic cable. Such a small-diameter and high bending-resistance fiber optic cable is particularly adapted for indoor cable routing.

2. The Prior Arts

In fiber-to-the-home (FTTH) optical communication network, the fiber optic cables used for accessing the clients or deployed in the horizontal pipelines of the buildings are often soft flexible cables and don't have a high bending-resistance.

Referring to FIG. 1, there is shown a cross-sectional view of a conventional soft flexible fiber optic cable. As shown in FIG. 1, the soft flexible fiber optic cable includes a single-core fiber 1 and an outer protection sheath 2. The outer protection sheath 2 is provided over the single-core fiber 1 for protecting the single-core fiber 1. Typically, the single-core fiber 1 is often further protected by a UV-curable resin layer. The outer protection sheath 2 is covered on the single-core fiber 1, thus configuring a cable structure. Further, although only one single-core fiber 1 is shown for exemplification in FIG. 1, in some other circumstances, multiple single-core fibers can be parallel arranged or stranded as a whole and then be covered by the outer protection sheath 2.

Referring to FIG. 2, there is shown a cross-section of another conventional soft flexible fiber optic cable. As shown in FIG. 2, the soft flexible fiber optic cable includes coloring optical fiber (or ribbon fiber or tight buffer optical fiber) 10 and an outer protection sheath 20. The outer protection sheath 20 is made of a plastic material such as polyvinyl chloride (PVC), polyethylene (PE), or low smoke zero halogen (LSZH). The soft flexible fiber optic cable, as shown in FIG. 2, may also includes a strengthening layer 30 disposed between the optical fiber 10 and the outer protection sheath 20. The strengthening layer 30 is an aramid yarn material which is soft and strong, and adapted for strengthening the structure of the soft flexible fiber optic cable.

Even when the conventional soft flexible fiber optic cable has a strengthening layer for strengthening the structure of the fiber optic cable, the rigidity of the aramid yarn material is still less than enough, so that the bending-resistance of the conventional soft flexible fiber optic cables is not satisfactory. When such a conventional soft flexible fiber optic cable is tightly tensioned and deployed in an indoor environment which may require the fiber optic cable to be frequently bent, the optical fiber contained therein is often likely to be damaged or even broken. Therefore, when the engineering staff tests the communication quality, they may have to spend a lot of time on checking broken places. In such a way, the maintenance cost is very high. Accordingly, a small-diameter high bending-resistance fiber optic cable is desired.

### SUMMARY OF THE INVENTION

A primary objective of the present invention is to provide a small-diameter high bending-resistance fiber optic cable. Specifically, the present invention is adapted for improving the tensile-resistance and bending-resistance of a small-diameter fiber optic cable, so as to provide an optimal protection to optical fibers contained therein for information transmission. As such, the present invention is also adapted for allowing the engineering staff to deploy the small-diameter fiber optic cable in narrow pipelines in the indoor environment, and reducing the possibility of breaking the optical fibers.

For achieving the foregoing objective, the present invention provides a small-diameter high bending-resistance fiber optic cable for obtaining a high tensile-resistance and a high bending-resistance. The small-diameter high bending-resistance fiber optic cable is particularly adapted for being deployed in indoor pipelines. The small-diameter high bending-resistance fiber optic cable includes at least one optical fiber, an outer protection sheath, and a plurality of tensile-resistance members. The optical fiber is positioned in a center of the outer protection sheath. The tensile-resistance members are uniformly distributed in the outer protection sheath. The tensile-resistance members are made of aramid yarn material.

According to an embodiment of the present invention, the small-diameter high bending-resistance fiber optic cable further includes a sheath strengthening member adapted for fixing the small-diameter high bending-resistance fiber optic cable. The small-diameter high bending-resistance fiber optic cable can be fixed by fixing the sheath strengthening member without fixing the optical transmission unit (e.g., the optical fibers). Therefore, when the small-diameter high bending-resistance fiber optic cable is fixed, the optical transmission unit is avoided from suffering mechanical impact. Alternatively, the sheath strengthening member having very strong mechanical strength instead of the optical transmission unit is fixed. Accordingly, the small-diameter high bending-resistance fiber optic cable can be conveniently deployed in many different sites.

According to another embodiment of the present invention, the small-diameter high bending-resistance fiber optic cable includes a hollow tube cable structure and an outer protection sheath. The outer protection sheath is provided over the hollow tube cable structure. The outer protection sheath includes a plurality of tensile-resistance members. The hollow tube cable structure is adapted for being provided with an optical transmission unit extending there through. In such a way, the present invention provides a small-diameter high bending-resistance fiber optic cable. A small-diameter high bending-resistance fiber optic cable can be obtained immediately before it is to be deployed by assembling an optical fiber inside the small-diameter high bending-resistance fiber optic cable. Accordingly, the present invention is adapted for avoiding the installation and assembly risk and assuring the quality of the optical fiber.

Generally, the present invention provides a solution to the difficulties of the conventional technologies, and drastically improves the overall tensile-resistance and bending-resistance of the small-diameter fiber optic cable, so as to allow the engineering staff to conveniently deploy the fiber optic cables in the indoor environment.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a cross-sectional view of a conventional flexible fiber optic cable;

FIG. 2 is a cross-sectional view of another conventional flexible fiber optic cable;

FIG. 3 is a cross-sectional view of a small-diameter high bending-resistance fiber optic cable according to a first embodiment of the present invention;

FIG. 4 is a cross-sectional view of a small-diameter high bending-resistance fiber optic cable according to a second embodiment of the present invention;

FIG. 5 is a cross-sectional view of a small-diameter high bending-resistance fiber optic cable according to a third embodiment of the present invention;

FIG. 6 is a cross-sectional view of a small-diameter high bending-resistance fiber optic cable according to a fourth embodiment of the present invention;

FIG. 7 is a cross-sectional view of a small-diameter high bending-resistance fiber optic cable according to a fifth embodiment of the present invention; and

FIG. 8 is a cross-sectional view of a small-diameter high bending-resistance fiber optic cable according to a sixth embodiment of the present invention.

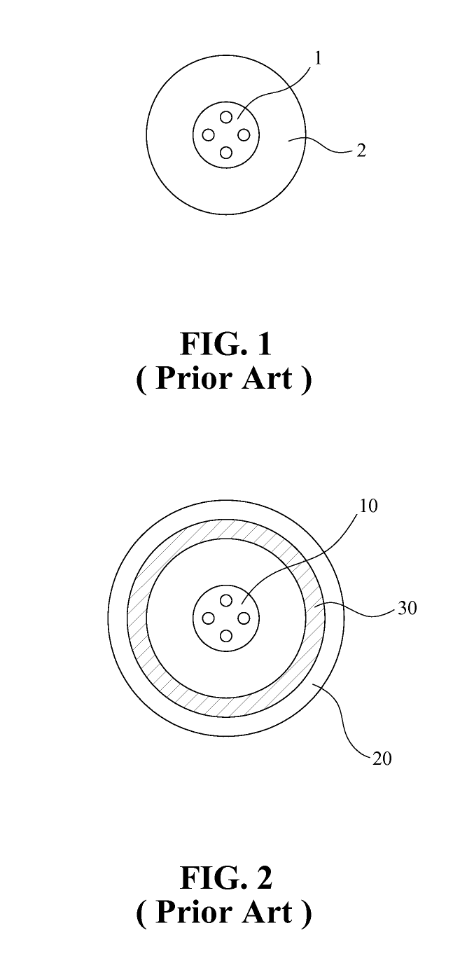

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

FTTH is signal transmission approach of optical communication which is often adopted by telecommunication service suppliers. According to the FTTH approach, fiber reaches the boundary of the living space, such as a box on the outside wall of a home. In other words, it is also known as “last mile” construction of the optical communication network to the client ends. The present invention provides a small-diameter high bending-resistance fiber optic cable specifically adapted for the “last mile” construction to the telecommunication box of the user's building.

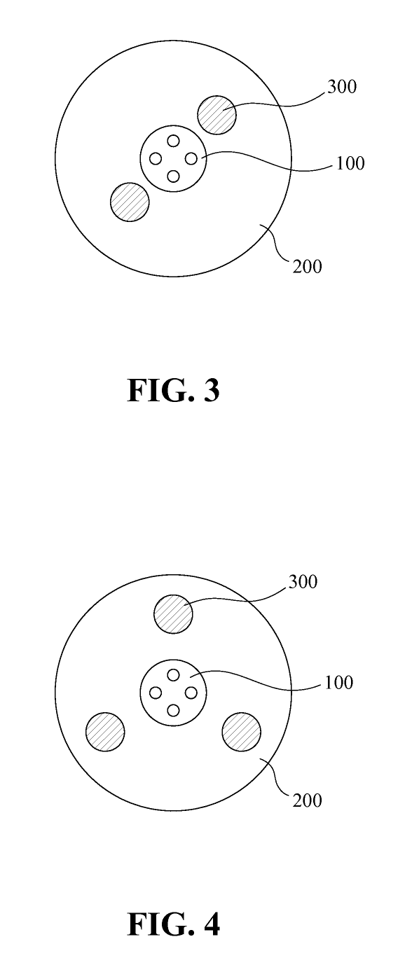

FIG. 3 is a cross-sectional view of a small-diameter high bending-resistance fiber optic cable according to a first embodiment of the present invention. Referring to FIG. 3, there is shown a small-diameter high bending-resistance fiber optic cable. The small-diameter high bending-resistance fiber optic cable has a diameter at least smaller than 6 mm. The small-diameter high bending-resistance fiber optic cable includes an optical communication unit 100, an outer protection sheath 200 and a plurality of tensile-resistance members 300. The optical communication unit 100 is a medium adapted for transmitting optical signals. The optical communication unit 100 includes at least one optical fiber. The optical fiber for example is a coloring fiber, a ribbon fiber, a tight buffer fiber, or any other suitable optical fibers. The outer protection sheath 200 is disposed over the optical communication unit 100. Relatively, the optical communication unit 100 is positioned at a center or other position of the outer protection sheath 200.

The outer protection sheath 200 is configured as a tube cable member having a cross-section of a round shape, an elliptical shape, or other suitable shapes. Such a specific shape of the outer protection sheath 200 is particularly adapted for providing an improved protection to the optical communication unit 100. It is known that when a square shaped tube cable or the like is applied with an external force, the pressures conveyed from different position to the optical fiber are inconsistent, and therefore the optical fiber is more likely to be broken. On the contrary, the round shaped or elliptical shaped outer protection sheath 200 conveys uniformly distributed pressure to the optical fiber, thus providing an overall protection thereto.

Each of the tensile-resistance members 300 is configured as a pipe member extending inside the outer protection sheath 200 along and in parallel with the optical communication unit 100. Each of the tensile-resistance members 300 has a cross-section of a round shape, an elliptical shape or other suitable shapes. As shown in FIG. 3, the small-diameter high bending-resistance fiber optic cable includes two tensile-resistance members 300. However, it should be noted that the quantity of the tensile-resistance members 300 employed inside the small-diameter high bending-resistance fiber optic cable can be practically modified and is not restricted by the present invention.

Preferably, the tensile-resistance members 300 are made of a fiber reinforced plastic (FRP) material. Specifically, the FRP material is selected from the group consisting of glass fiber reinforced plastic (GFRP), carbon fiber reinforced plastic (CFRP), and Keppra fiber reinforced plastic (KFRP). Alternatively, the tensile-resistance members 300 can also be steel wires.

FIG. 4 is a cross-sectional view of a small-diameter high bending-resistance fiber optic cable according to a second embodiment of the present invention. Referring to FIG. 4, there is shown a small-diameter high bending-resistance fiber optic cable. The small-diameter high bending-resistance fiber optic cable includes an optical communication unit 100 and three tensile-resistance members 300. The optical communication unit 100 includes four optical fibers. Referring to FIGS. 3 and 4 together, it can be learnt that the quantity of the optical fibers of the optical communication unit 100, the quantity of the tensile-resistance members 300, and the distribution thereof can be adaptively modified for satisfying practical requirements. The outer protection sheath 200 together with the associated tensile-resistance members 300 can effectively improve the bending and twisting of the fiber optic cable during the deploying operation.

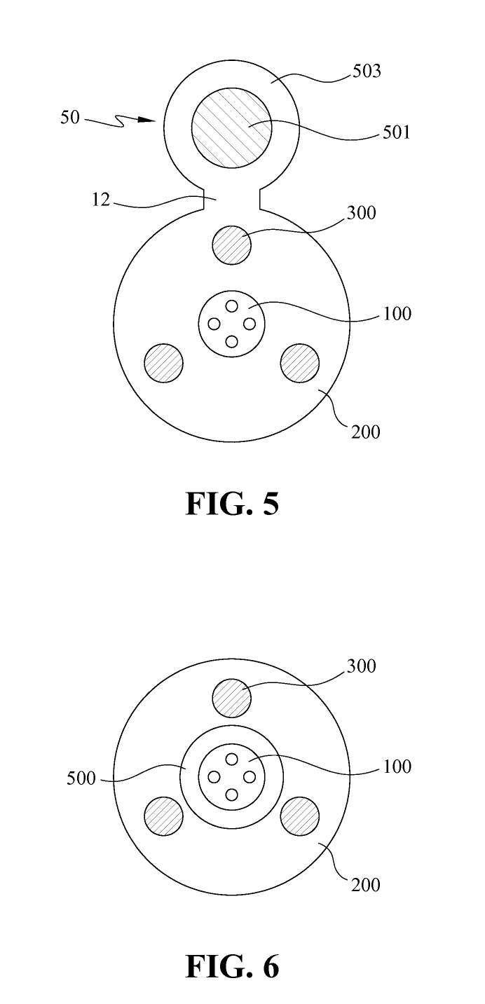

FIG. 5 is a cross-sectional view of a small-diameter high bending-resistance fiber optic cable according to a third embodiment of the present invention. Comparing with the first and the second embodiments, the small-diameter high bending-resistance fiber optic cable as shown in FIG. 5 further includes a sheath strengthening member 50, and a connection portion 12 connecting the optical communication unit 100 and the sheath strengthening member 50. The optical communication unit 100 and the sheath strengthening member 50 are parallel disposed. The sheath strengthening member 50 includes an outer layer and an inner layer. The outer layer of the sheath strengthening member 50 is a strengthening member 501 and the inner layer of the sheath strengthening member 50 is a protection member 503. The strengthening member 501 is adapted for improving a structural strength of the sheath strengthening member 50. The strengthening member 501 for example is made of a GFRP, a steel wire, or other suitable materials. The sheath strengthening member 50 provided for achieving the convenience of fixing the fiber optic cable. The fiber optic cable can be fixed by fixing the protection member 503 of the sheath strengthening member 50, or fixing the protection member 503 of the sheath strengthening member 50 together with the connection portion 12. In such a way, when the small-diameter high bending-resistance fiber optic cable is fixed, the optical transmission unit 100 is avoided from suffering mechanical impact. Alternatively, the sheath strengthening member 50 having very strong mechanical strength instead of the optical transmission unit 100 is fixed. Accordingly, the small-diameter high bending-resistance fiber optic cable can be conveniently deployed in many different sites.

FIG. 6 is a cross-sectional view of a small-diameter high bending-resistance fiber optic cable according to a fourth embodiment of the present invention. According to the third embodiment of the present invention, and comparing with the second embodiment as shown in FIG. 4, the small-diameter high bending-resistance fiber optic cable further includes an aramid yarn layer 500 disposed between the optical communication unit 100 and the outer protection sheath 200. The aramid yarn layer 500 circularly covers an outer surface of the optical communication unit 100. The aramid yarn layer 500 is constituted of a plurality of aramid yarns, and is adapted for improving a structural strength of the small-diameter high bending-resistance fiber optic cable.

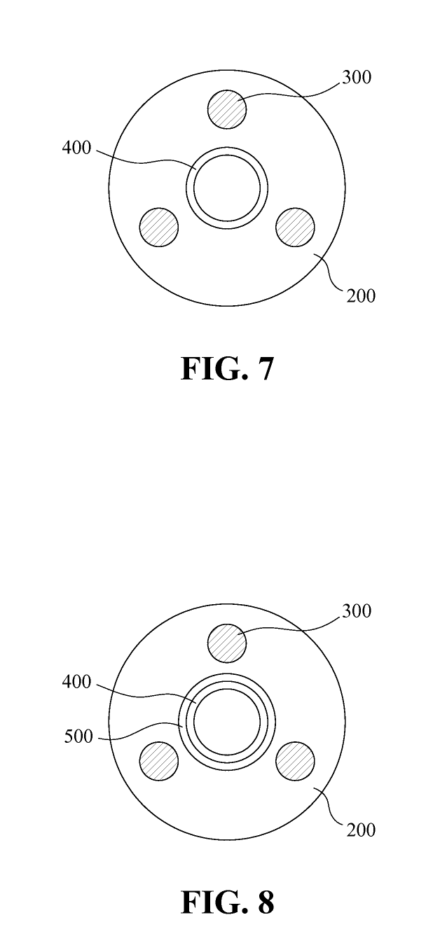

FIG. 7 is a cross-sectional view of a small-diameter high bending-resistance fiber optic cable according to a fifth embodiment of the present invention. Referring to FIG. 7, the small-diameter high bending-resistance fiber optic cable includes a hollow tube cable structure 400, an outer protection sheath 200, and a plurality of tensile-resistance members 300. The small-diameter high bending-resistance fiber optic cable has an outer diameter smaller than 6 mm. The outer protection sheath 200 is disposed over the hollow tube cable structure 400. The tensile-resistance members 300 are disposed inside and extending along the outer protection sheath 200. Preferably, the tensile-resistance members 300 are made of an FRP material. Specifically, the FRP material is selected from the group consisting of GFRP, CFRP, and steel wire. The hollow tube cable structure 400 is adapted for being provided with an optical transmission unit 100 extending there through. In such a way, the present invention provides a small-diameter high bending-resistance fiber optic cable. A small-diameter high bending-resistance fiber optic cable can be obtained immediately before it is to be deployed by assembling an optical fiber inside the small-diameter high bending-resistance fiber optic cable. The optical fiber for example is a coloring fiber, a ribbon fiber, a tight buffer fiber, or any other suitable optical fibers. Accordingly, the present invention is adapted for shortening the production period and assuring the quality of the optical fiber.

The hollow tube cable structure 400 is made of thermoplastic material, and more preferably a thermoplastic polyester elastomer having an optimal tenacity, deformation-resistance, and deflection-resistance.

FIG. 8 is a cross-sectional view of a small-diameter high bending-resistance fiber optic cable according to a sixth embodiment of the present invention. Comparing with the fifth embodiment of the present invention, the small-diameter high bending-resistance fiber optic cable further includes an aramid yarn layer 500 disposed between the hollow tube cable structure 400 and the outer protection sheath 200. The aramid yarn layer 500 circularly covers an outer surface of the hollow tube cable structure 400. The aramid yarn layer 500 is constituted of a plurality of aramid yarns, and is adapted for improving a structural strength of the small-diameter high bending-resistance fiber optic cable. When the fiber optic cable endures a tensile force, the aramid yarn layer 500 generates a counter force against the tensile force, such that the optical communication unit 100 can be protected thereby.

It should be noted that although not specifically disclosed in every embodiment of the present invention, the sheath strengthening member 50 as discussed in the third embodiment of FIG. 5 can be used in conjunction with any embodiment of the present invention, in which the sheath strengthening member 50 is required to be arranged in parallel with the hollow tube cable structure 400 or the optical communication unit 100.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A small-diameter high bending-resistance fiber optic cable, comprising:
an optical communication unit comprising at least one optical fiber;
an outer protection sheath disposed over the optical communication unit, wherein the optical communication unit is positioned at a center of the outer protection sheath; and
a plurality of tensile-resistance members uniformly distributed around the optical fiber in the outer protection sheath.

2. The small-diameter high bending-resistance fiber optic cable as claimed in claim 1, wherein the optical communication unit comprises a plurality of optical fibers.

3. The small-diameter high bending-resistance fiber optic cable as claimed in claim 2, wherein the optical fibers are coloring fibers, ribbon fibers, or tight buffer fibers.

4. The small-diameter high bending-resistance fiber optic cable as claimed in claim 1, wherein a diameter of the small-diameter high bending-resistance fiber optic cable is smaller than 6 mm.

5. The small-diameter high bending-resistance fiber optic cable as claimed in claim 1, wherein the tensile-resistance members are made of glass fiber reinforced plastics (GFRP), carbon fiber reinforced plastics (CFRP), or steel wires.

6. The small-diameter high bending-resistance fiber optic cable as claimed in claim 1, further comprising:
a sheath strengthening member comprising an inner layer severing as a strengthening member and an outer layer serving as a protection member, wherein the inner layer is made of a glass fiber reinforced plastic (GFRP) or a steel wire; and
a connection portion connecting between the sheath strengthening member and the outer protection sheath, wherein the sheath strengthening member is arranged parallel extending along with optical communication unit,
wherein the small-diameter high bending-resistance fiber optic cable is adapted for being fixed by fixing the sheath strengthening member.

7. The small-diameter high bending-resistance fiber optic cable as claimed in claim 1, further comprising an aramid yarn layer covered over the optical communication unit and positioned between the optical communication unit and the outer protection sheath.

8. A small-diameter high bending-resistance fiber optic cable, comprising:
a hollow tube cable structure having a hollow space;
an outer protection sheath disposed over the hollow tube cable structure; and
a plurality of tensile-resistance members uniformly distributed around the hollow tube cable structure in the outer protection sheath.

9. The small-diameter high bending-resistance fiber optic cable as claimed in claim 8, wherein the hollow space is adapted for allowing an optical communication unit and/or an metal conducting wire to be provided there through.

10. The small-diameter high bending-resistance fiber optic cable as claimed in claim 9, wherein the optical communication unit comprises a plurality of optical fibers.

11. The small-diameter high bending-resistance fiber optic cable as claimed in claim 10, wherein the optical fibers are coloring fibers, ribbon fibers, or tight buffer fibers.

12. The small-diameter high bending-resistance fiber optic cable as claimed in claim 8, wherein a diameter of the small-diameter high bending-resistance fiber optic cable is smaller than 6 mm.

13. The small-diameter high bending-resistance fiber optic cable as claimed in claim 8, wherein the hollow tube cable structure is made of a thermoplastic material.

14. The small-diameter high bending-resistance fiber optic cable as claimed in claim 8, wherein the tensile-resistance members are made of glass fiber reinforced plastics (GFRP), carbon fiber reinforced plastics (CFRP), or steel wires.

15. The small-diameter high bending-resistance fiber optic cable as claimed in claim 8, further comprising:
a sheath strengthening member comprising an inner layer severing as a strengthening member and an outer layer serving as a protection member, wherein the inner layer is made of a glass fiber reinforced plastic (GFRP) or a steel wire; and
a connection portion connecting between the sheath strengthening member and the outer protection sheath, wherein the sheath strengthening member is disposed in parallel with the hollow tube cable structure,
wherein the small-diameter high bending-resistance fiber optic cable is adapted for being fixed by fixing the sheath strengthening member.

16. The small-diameter high bending-resistance fiber optic cable as claimed in claim 8, further comprising an aramid yarn layer covered over the optical communication unit and positioned between the optical communication unit and the outer protection sheath.
